(19) United States
(12) Patent Application Publication
(10) Pub. No.: US 2026/0023500 A1
(43) Pub. Date: Jan. 22, 2026

(54) DELAYED EXECUTION OF A MULTIPLE-READ OPERATION

(71) Applicant: Micron Technology, Inc., Boise, ID (US)

(72) Inventor: Guiseppe Cariello, Boise, ID (US)

(21) Appl. No.: 19/261,048

(22) Filed: Jul. 7, 2025

Related U.S. Application Data
(60) Provisional application No. 63/674,004, filed on Jul. 22, 2024.

(51) Int. Cl. G06F 3/06

(52) U.S. Cl. CPC G06F 3/0655; G06F 3/0604; G06F 3/0679

(57) ABSTRACT

A memory device including a memory array and control logic, operatively coupled with the memory array, to perform operations including identifying, at a first time, a request to execute a multiple-read operation including a first sense sequence to read first data associated with a first page of multiple pages of a memory device and a second sense sequence to read second data associated with a second page of the multiple pages of the memory device. Execution of the multiple-read operation is caused to be delayed to a second time. At the second time, the execution of the multiple-read operation is caused, where the first sense sequence and a transfer of data associated with a prior operation via a communication interface associated with the memory device complete at substantially a same time.

### CROSS-REFERENCE TO RELATED APPLICATION

This application claims the benefit of U.S. Provisional Application No. 63/674,004, titled “Delayed Execution of a Multiple-Read Operation”, filed Jul. 22, 2024, which is hereby incorporated herein by reference in its entirety.

### TECHNICAL FIELD

Embodiments of the disclosure relate generally to memory sub-systems, and more specifically, relate to delaying execution of a multiple-read operation in a memory device of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with one or more embodiments of the present disclosure.

FIG. 1B is a block diagram of a memory device in communication with a memory sub-system controller of a memory sub-system in accordance with one or more embodiments of the present disclosure.

FIGS. 2A-2C are diagrams of portions of an example array of memory cells included in a memory device, in accordance with one or more embodiments of the present disclosure.

FIG. 3 illustrates an example timeline associated with activities performed by a communication interface of a memory sub-system and one or more wordlines associated with a set of pages (e.g., a first page and a second page) to be read by executing a multiple-read operation including a multiple-read delay, according to one or more embodiments of the present disclosure.

FIG. 4 illustrates an example timeline associated with activities performed by a communication interface of a memory sub-system and one or more wordlines associated with a set of pages (e.g., a first page, a second page, and a third page) to be read by executing a multiple-read operation including a multiple-read delay, according to one or more embodiments of the present disclosure.

FIG. 5 is a flow diagram of a method to execute a multiple-read operation including a delayed start to an initial or first sense sequence of the multiple-read operation, according to one or more embodiments of the present disclosure.

FIG. 6 is a block diagram of an example computer system in which embodiments of the present disclosure may operate.

### DETAILED DESCRIPTION

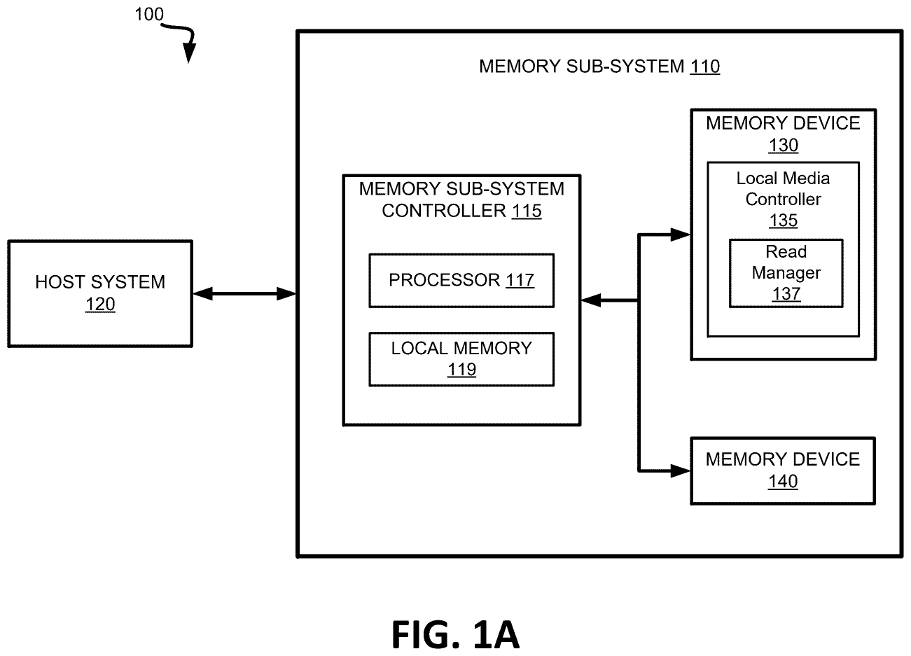

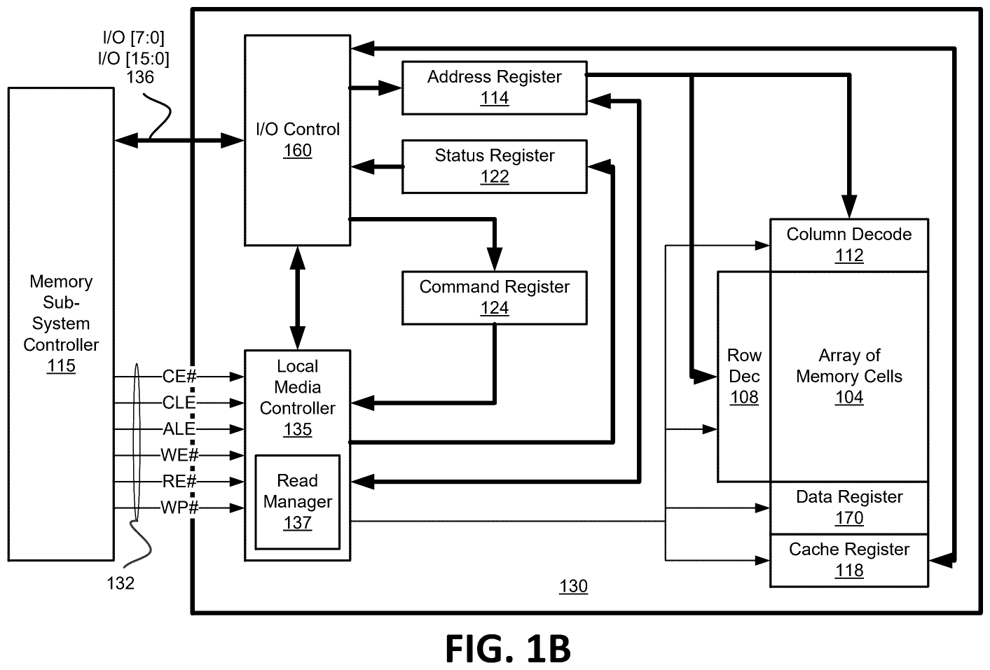

Aspects of the present disclosure are directed to delaying execution of a multiple-read operation in a memory device of a memory sub-system. A memory sub-system can be a storage device, a memory module, or a combination of a storage device and memory module. Examples of storage devices and memory modules are described below in conjunction with FIGS. 1A-1B. In general, a host system can utilize a memory sub-system that includes one or more components, such as memory devices that store data. The host system can provide data to be stored in the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIGS. 1A-1B. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns (also hereinafter referred to as bitlines) and rows (also hereinafter referred to as wordlines). A wordline can refer to one or more conductive lines of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For ease of description, these circuits can be generally referred to as independent plane driver circuits. Control logic on the memory device includes a number of separate processing threads to perform concurrent memory access operations (e.g., read operations, program operations, and erase operations). For example, each processing thread corresponds to a respective one of the memory planes and utilizes the associated independent plane driver circuits to perform the memory access operations on the respective memory plane. As these processing threads operate independently, the power usage and requirements associated with each processing thread also varies.

A memory device can be a three-dimensional (3D) memory device. For example, a 3D memory device can be a three-dimensional (3D) replacement gate memory device (e.g., 3D replacement gate NAND), which is a memory device with a replacement gate structure using wordline stacking. For example, a 3D replacement gate memory device can include wordlines, select gates, etc. located between sets of layers including a pillar (e.g., polysilicon pillar), a tunnel oxide layer, a charge trap (CT) layer, and a dielectric (e.g., oxide) layer. A 3D replacement gate memory device can have a “top deck” corresponding to a first side and a “bottom deck” corresponding to a second side. For example, the first side can be a drain side and the second side can be a source side. Data in a 3D replacement gate memory device can be stored as 1 bit/memory cell (SLC), 2 bits/memory cell (MLC), 3 bits/memory cell (TLC), etc.

In some memory sub-systems, a read operation is performed to read the data stored for each memory page in a selected block. Each read operation requires execution of multiple stages or sequences including a setup (or prologue) sequence, a sense sequence, and a discharge sequence. Accordingly, multiple individual read operations (including the multiple sequences) are executed to read multiple different memory pages, resulting the execution of multiple instances of the setup and discharge sequences.

To reduce the latency associated with the above approach, some systems employ a “seamless read operation” (also referred to as a “multiple-read operation”). A multiple-read operation includes a read operation (e.g., a single read operation) that is performed to read data from a set of multiple pages, where the setup and discharge sequences are “shared” during the reading of those multiple memory pages. As compared to performing an individual read operation for each page, the multiple-read operation includes a single setup sequence, followed by multiple sense sequences (i.e., a sense sequence for each of the pages being read), followed by a single discharge sequence. Accordingly, execution of a multiple-read operation reduces the read time associated with reading multiple pages by “skipping” the setup sequence and discharge sequence between two consecutive read operations associated with a same wordline or block.

Execution of a multiple-read operation can, however, result in memory cells can experiencing read disturb. Read disturb is the result of continually reading from one memory cell without intervening erase operations, causing other nearby memory cells to change over time (e.g., become programmed). If too many read operations are performed on a memory cell, data stored at adjacent memory cells of the memory component can become corrupted or incorrectly stored at the memory cell. This can result in a higher error rate of the data stored at the memory cell. This can increase the use of an error detection and correction operation (e.g., an error control operation) for subsequent operations (e.g., read and/or write) performed on the memory cell. The increased use of the error control operation can result in a reduction of the performance of a conventional memory sub-system. In addition, as the error rate for a memory cell or block continues to increase, it may even surpass the error correction capabilities of the memory sub-system, leading to an irreparable loss of the data. Furthermore, as more resources of the memory sub-system are used to perform the error control operation, fewer resources are available to perform other read operations or write operations.

Additional read disturb associated with the multiple-read operation can result due to limitations in the speed of the associated physical host interface (e.g., ONFI bus) that is used to transmit the data that is sensed or read from the multiple pages. In this regard, speed limitations associated with the physical host interface can result in a bottleneck which results in undesirable wait time during the in-progress multiple-read operation and additional read disturb caused by the memory array remaining polarized at the read voltage level (i.e., read stress) while waiting for the next command and for latch availability. Accordingly, the multiple-read operation can result in significant waiting time and additional read stress, particularly at the beginning of a new sequence of the multiple-read operation (e.g., prior to a sense sequence associated with a target page).

Aspects of the present disclosure address the above and other deficiencies by executing one or more multiple-read operations (e.g., one or mor seamless read operations) including multiple sense or sense sequences (e.g., a first sense sequence to read data from a first page, a second sense sequence to read data from a second page, etc.) to read data from multiple pages, where a delay period (herein referred to as a “multiple-read delay”) from a time of the multiple-read operation request is caused prior to a start of an initial sense sequence or initial read of the multiple pages. Advantageously, delaying the start of the initial sense sequence (i.e., the initial read) of the multiple-read operation by the multiple-read delay enables realignment of a completion or end of the first read of the multiple-read operation with a completion of the transfer of data read of a previous page (herein “previous page data”) by the communication interface to a host system. By employing the multiple-read delay to realign the completion of the first read of the multiple-read operation to coincide with the completion of the transfer of the previous page data, wait time of an in-progress multiple-read operation is eliminated or reduced, which eliminates or reduces the additional read disturb and read stress that can result from communication interface bottleneck.

Advantages of the present disclosure include, but are not limited to, improved memory sub-system performance and quality of service (QOS). For example, employing the multiple-read delay reduces the occurrence of polarizing the portion of the memory of a page at a read voltage as the array waits for a next read command. This results in the reduction or elimination of read disturb due to the unavailability of internal resources that are being used to store data associated with an operation (e.g., latches storing data for a read operation N), while data associated with a next operation (e.g., read operation N−1) is being transferred via the communication interface. In such cases, the data being transferred can be corrupted by a subsequent operation (e.g., N+1 read operation), if that operation starts prior to the completion of the data transfer via the communication interface data and prior to movement of the data associated with the N−1 operation from the internal latches. Accordingly, when the communication interface is slow, the availability of the internal resources (e.g., latches) is negatively impacted.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to a memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, compute express link (CXL) controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

According to embodiments, the local media controller 135 includes a read manager 137 configured to implement a multiple-read operation (e.g., a single read operation which includes shared setup and discharge sequences and multiple read or sense sequences to read data from multiple pages associated with one or more wordlines) including a multiple-read delay (e.g., a preset time period) prior to a first read sub-operation of the multiple-read operation. According to embodiments, the read manager 137 receive a request to execute a multiple-read operation to read a set of multiple pages of the memory device 130. In response to the request, the read manager 137 causes a delay of a predetermined time period (referred to as the multiple-read delay) prior to initiating execution of the requested multiple-read operation. For example, in response to a request for a multiple-read operation to read page X and page Y in a single read operation, the read manager 137 delays the start of the first sense or sense sequence in the set of requested reads (e.g., the sense sequence associated with page X) by the time period of the multiple-read delay. According to embodiments, delaying the start of the initial sense sequence of the multiple-read operation by the multiple-read delay enables realignment of a completion or end of the first read of the multiple-read operation with a completion of the transfer of data read of a previous page (herein “previous page data”) by a communication interface between the memory device 130 and the host system 120. Advantageously, employing the multiple-read delay to realign the completion of the first read of the multiple-read operation to coincide with the completion of the transfer of the previous page data eliminates or reduces a wait time of the in-progress multiple-read operation since the communication interface is made available upon the transfer completion. This further eliminates or reduces the additional read disturb and read stress that can result when a typical multiple-read operation (i.e., without a delayed start) is forced to wait for the communication interface to become available. Further details regarding the execution of one or more multiple-read operations including a multiple-read delay prior to a first read sub-operation are described below with reference to FIGS. 1B-6.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 112 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 112 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 112 to control the row decode circuitry 108 and column decode circuitry 112 in response to the addresses. In one embodiment, local media controller 135 includes the read manager 137, which can execute a multiple-read operation including a delayed start prior to reading multiple pages of the memory device 130.

The local media controller 135 is also in communication with a cache register 118. Cache register 118 latches data, either incoming or outgoing, as directed by the local media controller 135 to temporarily store data while the array of memory cells 104 is busy writing or reading, respectively, other data. During a program operation (e.g., write operation), data may be passed from the cache register 118 to the data register 170 for transfer to the array of memory cells 104; then new data may be latched in the cache register 118 from the I/O control circuitry 160. During a read operation, data may be passed from the cache register 118 to the I/O control circuitry 160 for output to the memory sub-system controller 115; then new data may be passed from the data register 170 to the cache register 118. The cache register 118 and/or the data register 170 may form (e.g., may form a portion of) a page buffer of the memory device 130. A page buffer may further include sensing devices (not shown in FIG. 1B) to sense a data state of a memory cell of the array of memory cells 204, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 160 and may then be written into command register 124. The addresses may be received over input/output (I/O) pins [7:0] of I/O bus 136 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 118. The data may be subsequently written into data register 170 for programming the array of memory cells 104.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIGS. 1A-1B has been simplified. It should be recognized that the functionality of the various block components described with reference to FIGS. 1A-1B may not necessarily be segregated to distinct components or component portions of an integrated circuit device. For example, a single component or component portion of an integrated circuit device could be adapted to perform the functionality of more than one block component of FIGS. 1A-1B. Alternatively, one or more components or component portions of an integrated circuit device could be combined to perform the functionality of a single block component of FIGS. 1A-1B. Additionally, while specific I/O pins are described in accordance with popular conventions for receipt and output of the various signals, it is noted that other combinations or numbers of I/O pins (or other I/O node structures) may be used in the various embodiments.

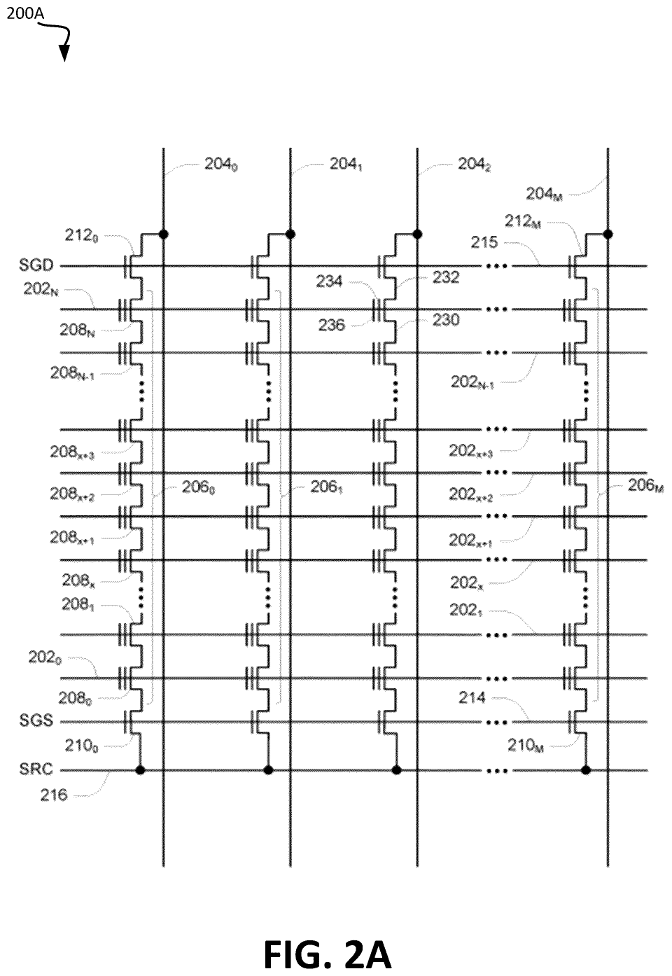

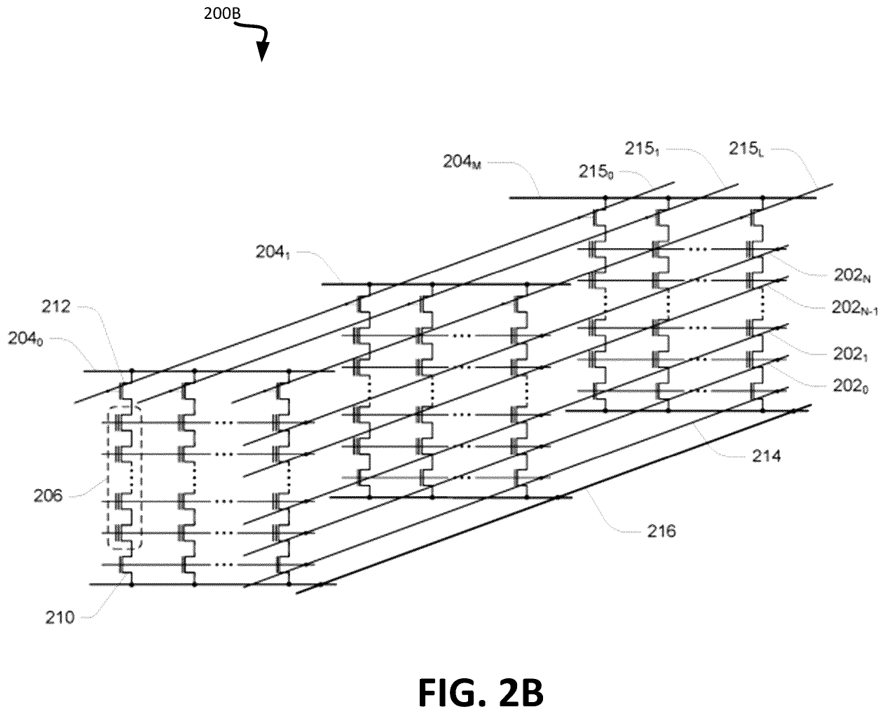

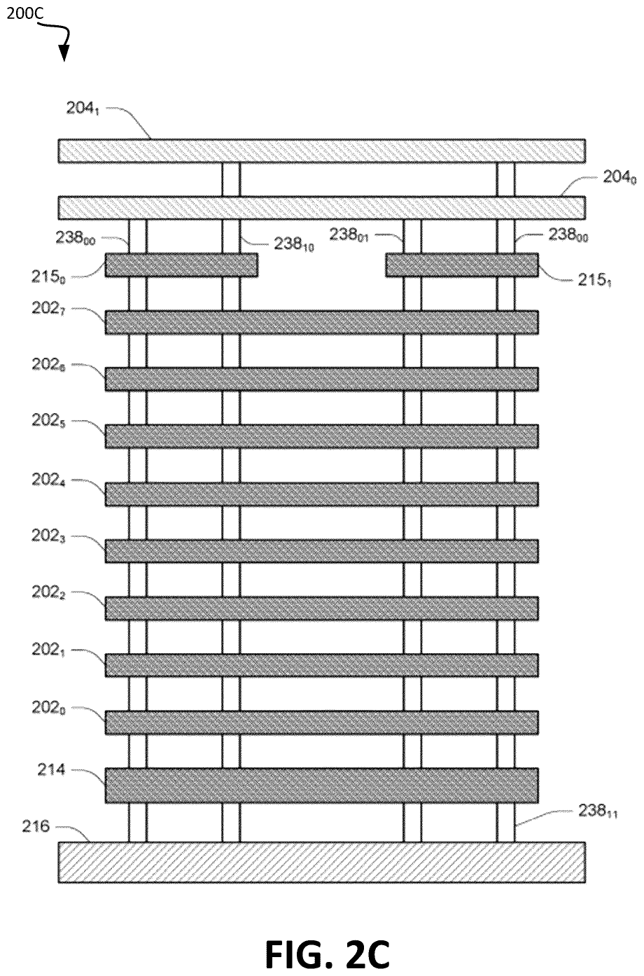

FIGS. 2A-2C are diagrams of portions of an example array of memory cells included in a memory device, in accordance with some embodiments of the present disclosure. For example, FIG. 2A is a schematic of a portion of an array of memory cells 200A as could be used in a memory device (e.g., as a portion of array of memory cells 104). Memory array 200A includes access lines, such as wordlines 202₀ to 202_{N}, and a data line, such as bitline 204. The wordlines 202 may be connected to global access lines (e.g., global wordlines), not shown in FIG. 2A, in a many-to-one relationship. For some embodiments, memory array 200A may be formed over a semiconductor that, for example, may be conductively doped to have a conductivity type, such as a p-type conductivity, e.g., to form a p-well, or an n-type conductivity, e.g., to form an n-well.

Memory array 200A can be arranged in rows each corresponding to a respective wordline 202 and columns each corresponding to a respective bitline 204. Rows of memory cells 208 can be divided into one or more groups of physical pages of memory cells 208, and physical pages of memory cells 208 can include every other memory cell 208 commonly connected to a given wordline 202. For example, memory cells 208 commonly connected to wordline 202_{N} and selectively connected to even bitlines 204 (e.g., bitlines 204₀, 204₂, 204₄, etc.) may be one physical page of memory cells 208 (e.g., even memory cells) while memory cells 208 commonly connected to wordline 202_{N} and selectively connected to odd bitlines 204 (e.g., bitlines 204₁, 204₃, 204₅, etc.) may be another physical page of memory cells 208 (e.g., odd memory cells). Although bitlines 204₃-204₅ are not explicitly depicted in FIG. 2A, it is apparent from the figure that the bitlines 204 of the array of memory cells 200A may be numbered consecutively from bitline 204₀ to bitline 204_{M}. Other groupings of memory cells 208 commonly connected to a given wordline 202 may also define a physical page of memory cells 208. For certain memory devices, all memory cells commonly connected to a given wordline might be deemed a physical page of memory cells. The portion of a physical page of memory cells (which, in some embodiments, could still be the entire row) that is read during a single read operation or programmed during a single programming operation (e.g., an upper or lower page of memory cells) might be deemed a logical page of memory cells. A block of memory cells may include those memory cells that are configured to be erased together, such as all memory cells connected to wordlines 202₀-202_{N} (e.g., all strings 206 sharing common wordlines 202). Unless expressly distinguished, a reference to a page of memory cells herein refers to the memory cells of a logical page of memory cells.

Each column can include a string of series-connected memory cells (e.g., non-volatile memory cells), such as one of strings 2060 to 206. Each string 206 can be connected (e.g., selectively connected) to a source line 216 (SRC) and can include memory cells 208₀ to 208_{N}. The memory cells 208 of each string 206 can be connected in series between a select gate 210, such as one of the select gates 210₀ to 210_{M}, and a select gate 212, such as one of the select gates 212₀ to 212_{M}. In some embodiments, the select gates 210₀ to 210_{M} are source-side select gates (SGS) and the select gates 212₀ to 212_{M} are drain-side select gates. Select gates 210₀ to 210_{M} can be connected to a select line 214 (e.g., source-side select line) and select gates 212₀ to 212_{M} can be connected to a select line 215 (e.g., drain-side select line). The select gates 210 and 212 might represent a plurality of select gates connected in series, with each select gate in series configured to receive a same or independent control signal. A source of each select gate 210 can be connected to SRC 216, and a drain of each select gate 210 can be connected to a memory cell 208₀ of the corresponding string 206. Therefore, each select gate 210 can be configured to selectively connect a corresponding string 206 to SRC 216. A control gate of each select gate 210 can be connected to select line 214. The drain of each select gate 212 can be connected to the bitline 204 for the corresponding string 206. The source of each select gate 212 can be connected to a memory cell 208_{N} of the corresponding string 206. Therefore, each select gate 212 might be configured to selectively connect a corresponding string 206 to the bitline 204. A control gate of each select gate 212 can be connected to select line 215.

In some embodiments, and as will be described in further detail below with reference to FIG. 2B, the memory array in FIG. 2A is a three-dimensional memory array, in which the strings 206 extend substantially perpendicular to a plane containing SRC 216 and to a plane containing a plurality of bitlines 204 that can be substantially parallel to the plane containing SRC 216.

FIG. 2B is another schematic of a portion of an array of memory cells 200B (e.g., a portion of the array of memory cells 104) arranged in a three-dimensional memory array structure. The three-dimensional memory array 200B may incorporate vertical structures which may include semiconductor pillars where a portion of a pillar may act as a channel region of the memory cells of strings 206. The strings 206 may be each selectively connected to a bit line 204₀-204_{M} by a select gate 212 and to the SRC 216 by a select gate 210. Multiple strings 206 can be selectively connected to the same bitline 204. Subsets of strings 206 can be connected to their respective bitlines 204 by biasing the select lines 215₀-215_{L} to selectively activate particular select gates 212 each between a string 206 and a bitline 204. The select gates 210 can be activated by biasing the select line 214. Each wordline 202 may be connected to multiple rows of memory cells of the memory array 200B. Rows of memory cells that are commonly connected to each other by a particular wordline 202 may collectively be referred to as tiers.

FIG. 2C is a diagram of a portion of an array of memory cells 200C (e.g., a portion of the array of memory cells 104). Channel regions (e.g., semiconductor pillars) 238₀₀ and 238₀₁ represent the channel regions of different strings of series-connected memory cells (e.g., strings 206 of FIGS. 2A-2B) selectively connected to the bitline 204₀. Similarly, channel regions 238₁₀ and 238₁₁ represent the channel regions of different strings of series-connected memory cells (e.g., NAND strings 206 of FIGS. 2A-2B) selectively connected to the bitline 204₁. A memory cell (not depicted in FIG. 2C) may be formed at each intersection of a wordline 202 and a channel region 238, and the memory cells corresponding to a single channel region 238 may collectively form a string of series-connected memory cells (e.g., a string 206 of FIGS. 2A-2B). Additional features might be common in such structures, such as dummy wordlines, segmented channel regions with interposed conductive regions, etc.

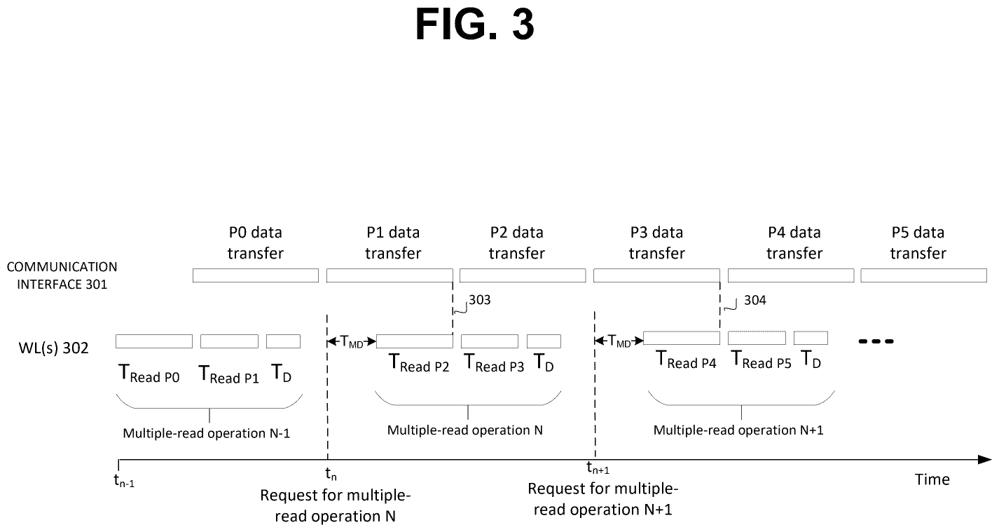

FIG. 3 illustrates an example timeline associated with activities performed by a communication interface 301 of a memory sub-system (e.g., memory sub-system 110 of FIG. 1A) and one or more wordlines 302 associated with a set of pages to be read by executing a multiple-read operation including a multiple-read delay, according to one or more embodiments of the present disclosure. In the example shown in FIG. 3, each multiple-read operation (e.g., multiple-read operation N−1, multiple-read operation N, and multiple-read operation N+1) includes two read or sense sequences (i.e., each multiple-read operation includes reading two pages in a single operation having shared setup and discharge sequences).

As shown in FIG. 3, at a time (tₙ₋₁), multiple-read operation N−1 is executed during which page 0 (P0) and page 1 (P1) associated with one or more wordlines 302 are read. As illustrated, multiple-read operation N−1 includes a first time period or duration (TRead P0) during which data associated with P0 is sensed or read, a second time period or duration (TRead P1) during which data associated with P1 is sensed or read, and a third time period or duration (TD) during which a shared discharge associated with the reading of both P0 and P1 is performed. Although not shown, a portion of the T_{Read P0} period may include execution of a setup sequence associated with the multiple-read operation N−1.

As shown in FIG. 3, following completion of T_{Read P0}, the communication interface 301 (e.g., an ONFI interface providing communication with the host system) is used to transfer the read data associated with P0 to the host system (i.e., the P0 data transfer). As illustrated, at a time (tₙ), a request to perform multiple-read operation N is identified by control logic (e.g., read manager 137 of FIGS. 1A and 1B) of a local media controller (e.g., local media controller 135 of FIGS. 1A and 1B) of a memory device (e.g., memory device 130 of FIGS. 1A and 1B). In the example shown in FIG. 3, multiple-read operation N includes reading page 2 (P2) and page 3 (P3) associated with one or more wordlines 302.

As illustrated in FIG. 3, at the time the request for multiple-read operation N is received (i.e., tₙ), communication interface 301 is busy transferring data (e.g., the P1 data transfer) associated with the previous operation (e.g., multiple-read operation N−1). According to embodiments, in response to the request to execute multiple-read operation N, the control logic (e.g., read manager 137 of FIGS. 1A and 1B) causes a start of multiple-read operation N to be delayed by a time period (i.e., the multiple-read delay T_{MD}).

According to embodiments, as shown by dashed line 303, an end or completion of a first sense sequence (e.g., reading of P2) of multiple-read operation N aligns with an end or completion of the transfer of data (e.g., the P1 data transfer) associated with the previous operation (e.g., multiple-read operation N−1). According to embodiments, causing the start of the first sense sequence (e.g., the P2 sense sequence) of multiple-read operation N to be delayed by the multiple-read delay T_{MD} enables the alignment 303, such that a next sense sequence (e.g., the P3 sense sequence) can be executed without undesirable waiting time associated with the communication interface 301. Advantageously, the alignment and corresponding elimination or reduction in such waiting time enables the elimination or reduction in extra read stress that results when a typical multiple-read operation (i.e., a multiple-read operation that does not include a multiple-read delay) is executed.

As illustrated, at a time (tₙ₊₁), a request to perform multiple-read operation N+1 is identified by control logic (e.g., read manager 137 of FIGS. 1A and 1B). In the example shown in FIG. 3, multiple-read operation N+1 includes reading page 4 (P4) and page 5 (P5) associated with one or more wordlines 302. As illustrated in FIG. 3, at the time the request for multiple-read operation N+1 is received (i.e., tₙ₊₁), communication interface 301 is busy transferring data (e.g., the P3 data transfer) associated with the previous operation (e.g., multiple-read operation N+1). According to embodiments, in response to the request to execute multiple-read operation N+1, the control logic (e.g., read manager 137 of FIGS. 1A and 1B) causes a start of multiple-read operation N+1 to be delayed by the multiple-read delay T_{MD}.

As described above, as shown by dashed line 304, an end or completion of a first sense sequence (e.g., reading of P2) of multiple-read operation N+1 aligns with an end or completion of the transfer of data (e.g., the P3 data transfer) associated with the previous operation (e.g., multiple-read operation N). According to embodiments, alignment 304 eliminates or reduces a wait time associated with executing the next sense sequence (e.g., the reading of P5), since communication interface 301 is in a ready state and available.

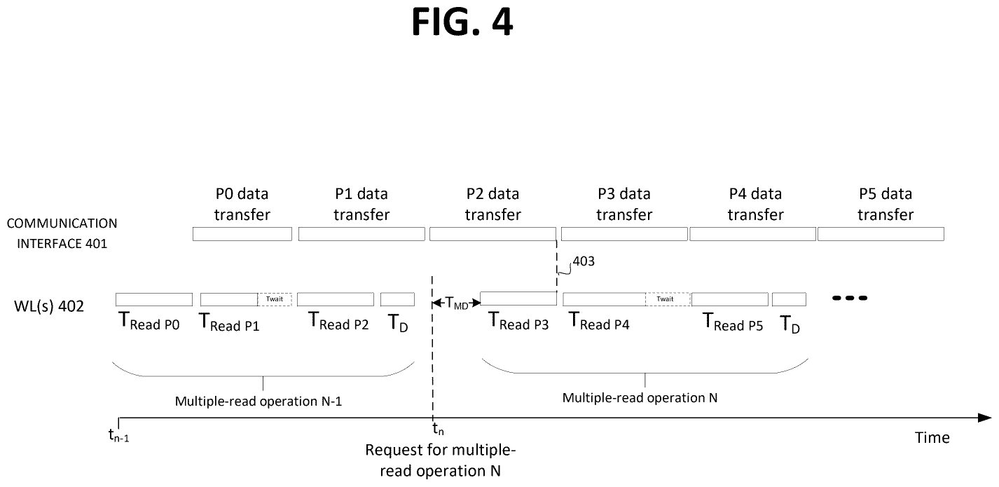

FIG. 4 illustrates an example timeline associated with activities performed by a communication interface 401 of a memory sub-system (e.g., memory sub-system 110 of FIG. 1A) and one or more wordlines 402 associated with a set of pages to be read by executing a multiple-read operation including a multiple-read delay, according to one or more embodiments of the present disclosure. In the example shown in FIG. 4, each multiple-read operation (e.g., multiple-read operation N−1, multiple-read operation N, and multiple-read operation N+1) includes three read or sense sequences (i.e., each multiple-read operation includes reading a set of three pages in a single operation having shared setup and discharge sequences).

Like the example described above, as shown in FIG. 4, at a time (tₙ₋₁), multiple-read operation N−1 is executed during which page 0 (P0), page 1 (P1), and page 2 (P2) associated with one or more wordlines 402 are read. As illustrated, multiple-read operation N−1 includes a first time period or duration (TRead P0) during which data associated with P0 is sensed or read, a second time period or duration (TRead P1) during which data associated with P1 is sensed or read, a third time period or duration (TRead P2) and a fourth time period or duration (T_{D}) during which a shared discharge associated with the reading of both P0 and P1 is performed. Although not shown, a portion of the TRead P0 period may include execution of a setup sequence associated with the multiple-read operation N−1.

As illustrated in FIG. 4, following completion of the sense sequence associated with P0, a sense sequence associated with P1 of multiple-read operation N−1 is performed during TRead P1 and the communication interface 401 is used to transfer the read data associated with P0 to the host system (i.e., the P0 data transfer). Following completion of the sense sequence associated with P1, a sense sequence associated with P2 of multiple-read operation N−1 is performed during TRead P2 and the communication interface 401 is used to transfer the read data associated with P1 to the host system (i.e., the P1 data transfer). It is noted that there may be waiting time (T_{wait}; as denoted by dashed lines) prior to starting the P2 sense sequence of the multiple-read operation N−1 as a result of the communication interface 401 being busy with the P0 data transfer.

As illustrated, at a time (tₙ), a request to perform multiple-read operation N is identified by control logic (e.g., read manager 137 of FIGS. 1A and 1B) of a memory device (e.g., memory device 130 of FIGS. 1A and 1B). In the example shown in FIG. 4, multiple-read operation N includes reading page 3 (P3), page 4 (P4), and page 5 (P5) associated with one or more wordlines 402.

As illustrated in FIG. 4, at the time the request for multiple-read operation N is received (i.e., tₙ), communication interface 401 is busy transferring data (e.g., the P2 data transfer) associated with the previous operation (e.g., multiple-read operation N−1). According to embodiments, in response to the request to execute multiple-read operation N, the control logic (e.g., read manager 137 of FIGS. 1A and 1B) causes a start of multiple-read operation N to be delayed by a time period (i.e., the multiple-read delay T_{MD}).

According to embodiments, as shown by dashed line 403, an end or completion of a first sense sequence (e.g., reading of P3) of multiple-read operation N aligns with an end or completion of the transfer of data (e.g., the P2 data transfer) associated with the previous operation (e.g., multiple-read operation N−1). According to embodiments, causing the start of the first sense sequence (e.g., the P3 sense sequence) of multiple-read operation N to be delayed by the multiple-read delay T_{MD} enables the alignment 403, such that a next sense sequence (e.g., the P4 sense sequence) can be executed without undesirable waiting time associated with the communication interface 401. This results in the elimination or a reduction in read disturb that can be caused by read stress (the memory array remaining polarized) during a waiting time when the communication interface 401 is busy transferring data.

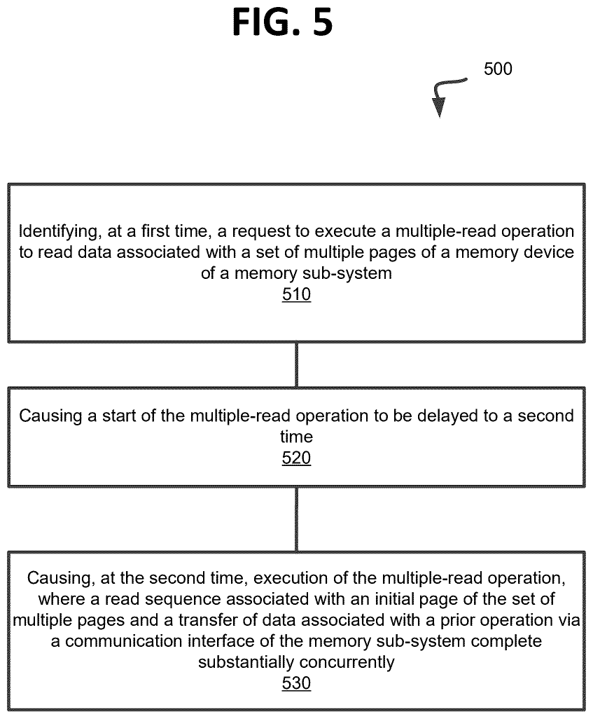

FIG. 5 is a flow diagram of a method 500 to cause execution of a multiple-read operation (e.g., a seamless read operation) including multiple sense or sense sequences (e.g., a first sense sequence to read data from a first page, a second sense sequence to read data from a second page, etc.) to read data from multiple pages in a single operation (e.g., with a shared setup and discharge sequence), where a delay period (i.e., the multiple-read delay) from a time of the multiple-read operation request is caused prior to a start of an initial sense sequence (i.e., initial read) of the multiple pages, in accordance with some embodiments of the present disclosure. The method 500 can be performed by control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the local media controller 135 and/or the read manager 137 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, a request is identified. For example, control logic can identify, at a first time, a request to execute a multiple-read operation including a first sense sequence to read first data associated with a first page of a plurality of pages of a memory device and a second sense sequence to read second data associated with a second page of the plurality of pages of the memory device. In an embodiment, the request to perform the multiple-read operation (e.g., multiple-read operation N of FIGS. 3 and 4) is received at the first time to read multiple the pages (e.g., page 2 and page 3 of FIG. 3) in the same or single operation (e.g., a read operation including a shared setup sequence, multiple sense sequences, and a shared discharge sequence). At operation 520, a delay is caused. For example, control logic can cause execution of the multiple-read operation to be delayed to a second time. In an embodiment, the delay period (e.g., the multiple-read operation delay of FIGS. 3 and 4) is a preset or predetermined duration that can be caused from the time of identifying the request (i.e., the first time) to perform the multiple-read operation. In an embodiment, the delay period is a duration that spans from the first time to a second time.

At operation 530, an operation is executed. For example, control logic can cause, at the second time, the execution of the multiple-read operation, where the first sense sequence and a transfer of data associated with a prior operation via a communication interface associated with the memory device complete at substantially a same time (e.g., substantially concurrently). In an embodiment, with reference to the example shown in FIG. 3, the initial or first page of the multiple pages associated with the multiple-read operation is P2. In an embodiment, the delay period (e.g., T_{MD}) of FIGS. 3 and 4) that is waited prior to starting the read or sense sequence of the first page in the set of multiple pages (e.g., P2) causes the completion of the sense sequence of the first page to align or coincide in time (e.g., occur substantially concurrently) with a completion of a data transfer of a read data associated with a previous operation (e.g., the P1 data transfer of FIG. 3) by a communication interface of the memory sub-system. Advantageously, the alignment in time (e.g., the substantially concurrent completion) of the completion of the first sense sequence of the multiple-read operation being execute and the transfer of data associated with a previous operation by the communication interface (e.g., transfer of the read data to the host system) enables a waiting time (and associated read stress) between the first sense sequence and a next sense sequence to be eliminated or reduced. Further details regarding operations 510-530 are described above with reference to FIGS. 1A-4.

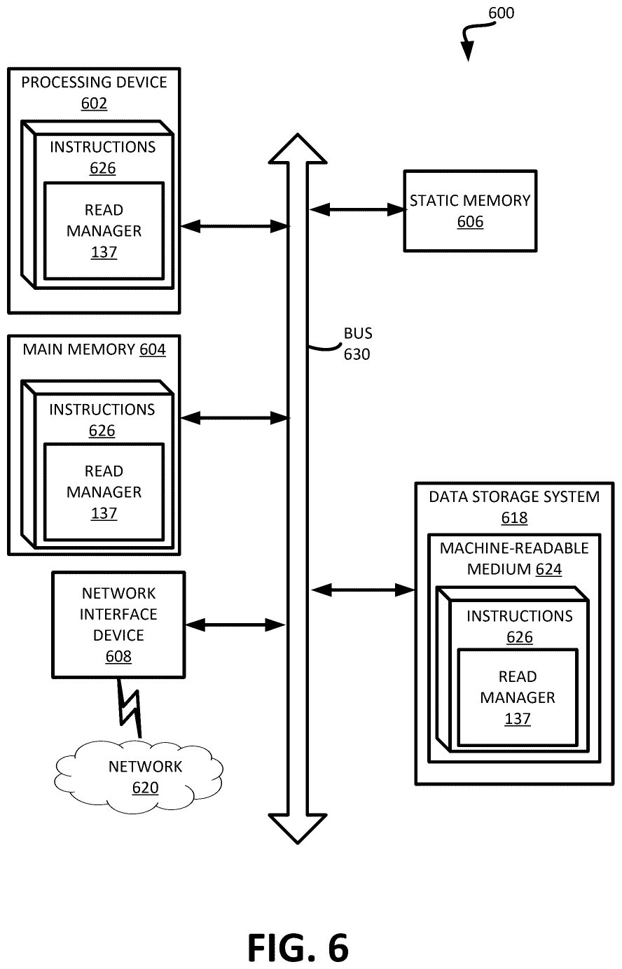

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the local media controller 135 and/or the read manager 137 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to a local media controller and/or PPM component (e.g., the local media controller 135 and/or the read manager 136 of FIG. 1A). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array; and
control logic, operatively coupled with the memory array, to perform operations comprising:
identifying, at a first time, a request to execute a multiple-read operation comprising a first sense sequence to read first data associated with a first page of a plurality of pages of the memory device and a second sense sequence to read second data associated with a second page of the plurality of pages of the memory device;
causing execution of the multiple-read operation to be delayed to a second time; and
causing, at the second time, the execution of the multiple-read operation, wherein the first sense sequence and a transfer of data associated with a prior operation via a communication interface associated with the memory device complete at substantially a same time.

2. The memory device of claim 1, wherein the execution of the multiple-read operation is delayed by a delay period.

3. The memory device of claim 1, wherein the multiple-read operation comprises a setup sequence associated with the first sense sequence and the second sense sequence.

4. The memory device of claim 3, wherein the multiple-read operation comprises a discharge sequence associated with the first sense sequence and the second sense sequence.

5. The memory device of claim 1, wherein the communication interface transfers, at a third time following completion of a first sense operation of the first sense sequence, first data associated with the first page.

6. The memory device of claim 5, wherein the second sense sequence is executed at the third time.

7. The memory device of claim 6, wherein a discharge sequence associated with the first sense sequence and the second sense sequence completes prior to completion of transferring, by the communication interface, of second data associated with the second sense sequence.

8. A method comprising:
identifying, at a first time, a request to execute a multiple-read operation comprising a first sense sequence to read first data associated with a first page of a plurality of pages of a memory device and a second sense sequence to read second data associated with a second page of the plurality of pages of the memory device;
causing execution of the multiple-read operation to be delayed to a second time; and
causing, at the second time, the execution of the multiple-read operation, wherein the first sense sequence and a transfer of data associated with a prior operation via a communication interface associated with the memory device complete at substantially a same time.

9. The method of claim 8, wherein the execution of the multiple-read operation is delayed by a delay period.

10. The method of claim 8, wherein the multiple-read operation comprises a setup sequence associated with the first sense sequence and the second sense sequence.

11. The method of claim 10, wherein the multiple-read operation comprises a discharge sequence associated with the first sense sequence and the second sense sequence.

12. The method of claim 8, wherein the communication interface transfers, at a third time following completion of a first sense operation of the first sense sequence, first data associated with the first page.

13. The method of claim 12, wherein the second sense sequence is executed at the third time.

14. The method of claim 13, wherein a discharge sequence associated with the first sense sequence and the second sense sequence completes prior to completion of transferring, by the communication interface, of second data associated with the second sense sequence.

15. A non-transitory computer-readable storage medium comprising instructions that, when executed by a processing device, cause the processing device to perform operations comprising:
identifying, at a first time, a request to execute a multiple-read operation comprising a first sense sequence to read first data associated with a first page of a plurality of pages of a memory device and a second sense sequence to read second data associated with a second page of the plurality of pages of the memory device;
causing execution of the multiple-read operation to be delayed to a second time; and
causing, at the second time, the execution of the multiple-read operation, wherein the first sense sequence and a transfer of data associated with a prior operation via a communication interface associated with the memory device complete at substantially a same time.

16. The non-transitory computer-readable storage medium of claim 15, wherein the execution of the multiple-read operation is delayed by a delay period.

17. The non-transitory computer-readable storage medium of claim 15, wherein the multiple-read operation comprises:
a setup sequence associated with the first sense sequence and the second sense sequence; and
a discharge sequence associated with the first sense sequence and the second sense sequence.

18. The non-transitory computer-readable storage medium of claim 15, wherein the communication interface transfers, at a third time following completion of a first sense operation of the first sense sequence, first data associated with the first page.

19. The non-transitory computer-readable storage medium of claim 18, wherein the second sense sequence is executed at the third time.

20. The non-transitory computer-readable storage medium of claim 19, wherein a discharge sequence associated with the first sense sequence and the second sense sequence completes prior to completion of transferring, by the communication interface, of second data associated with the second sense sequence.
